(19) United States
(12) Patent Application Publication
(10) Pub. No.: US 2004/0205249 A1
(43) Pub. Date: Oct. 14, 2004

(54) Methods and systems for determining whether to compress computer communications

(75) Inventor: Wayne Berry, Bellingham, WA (US)

Correspondence Address: Steven H. Arterberry, Esq., DORSEY & WHITNEY LLP, Suite 3400, 1420 Fifth Avenue, Seattle, WA, 98101, US

(73) Assignee: POST POINT SOFTWARE, INC.

(21) Appl. No.: 10/391,050

(22) Filed: Mar. 17, 2003

(51) Int. Cl. G06F 15/16

(52) U.S. Cl. 709/247

(57) ABSTRACT

Methods and systems for determining whether to compress computer communications are disclosed. In one embodiment, a method includes examining at least one of a request characteristic of the communication request and a response characteristic of the uncompressed responsive communication, the request characteristic of the communication request being other than an “accept-encoding” header, and applying one or more rules to the at least one of the request characteristic and the response characteristic. Each of the one or more rules provides a compressibility assessment. Based on the one or more compressibility assessments, the method then determines whether to compress the responsive communication prior to transmittal to the requester.

### TECHNICAL FIELD

The present invention relates to methods and systems of determining whether to compress a computer communication, and more specifically, whether to compress an HTTP response prior to transmittal to a requester.

### BACKGROUND OF THE INVENTION

Many Internet Service Providers (ISP's) charge their customers based on bandwidth. The customers pay the ISP for hosting their web-based applications on a web server. Generally, such customers want to pay less and get more bandwidth. Each user that browses to the customer's web site makes a request of the web server for some content. The web server may need to generate this content or just locate a static file, such as an image.

Today's browsers have built-in technology to uncompress data before displaying the data in the browser. Typically, a browser may indicate that it possesses this capability by sending a HyperText Transfer Protocol (HTTP) request header called an “accept-encoding” header that includes an indication of the type of encoding that the browser can accept. Unfortunately, many existing browsers send the “accept-encoding” header yet fail to uncompress the data correctly, depending on the type of data being received.

When the web server receives the “accept-encoding” header from the browser (or client), the web server has the option of compressing an HTTP response to improve the throughput of the web server. Most compressible transmissions, regardless of origination (i.e. XML, ASP, cgi, JSP, DHTML, HTML, java script, etc.) can typically achieve 80% compression or more. Most web servers, however, simply serve each HTTP response to the browser in an uncompressed state. They do this to avoid browser bugs as mentioned above, and because compression is CPU intensive.

Typical compression processes reduce the total bandwidth usage by about one third while improving network transmission times for compressed content by about 400%, advantageously reducing capital and operating expenditures. Users who browse to a web site that compresses the output experience a large benefit as well. For example, a user who connects to a web site that compresses the HTTP response will download a page that is typically 80% smaller than the same non-compressed page. Thus, the user will see the compressed pages faster. For these reasons, a need exists for methods and systems for determining whether to compress an HTTP response based on more than merely evaluating the “accept-encoding” header to determine if a response should be compressed.

### SUMMARY OF THE INVENTION

The present invention is directed to methods and systems of determining whether to compress a computer communication, and more particularly, determining whether to compress an HTTP response. In one aspect, a method includes examining at least one of a request characteristic of the communication request and a response characteristic of the uncompressed responsive communication, the request characteristic of the communication request being other than an “accept-encoding” header, and applying one or more rules to the at least one of the request characteristic and the response characteristic. Each of the one or more rules provides a compressibility assessment. Based on the one or more compressibility assessments, the method then determines whether to compress the responsive communication prior to transmittal to the requester.

### BRIEF DESCRIPTION OF THE DRAWINGS

FIG. 1 is a flow diagram illustrating a process for determining whether to compress an HTTP response in accordance with an embodiment of the invention.

FIG. 2 is a table illustrating a representative list of content types and a corresponding representative list of browser types, in accordance with an embodiment of the invention.

FIG. 3 is a table illustrating a representative list of regular expressions that may be used to determine a browser version based on a User-Agent header in accordance with one embodiment of the invention.

FIG. 4 is a typical network environment having multiple web servers in accordance with an alternate embodiment of the invention.

FIG. 5 is a typical network environment having a single web server in accordance with another embodiment of the invention.

### DETAILED DESCRIPTION OF THE INVENTION

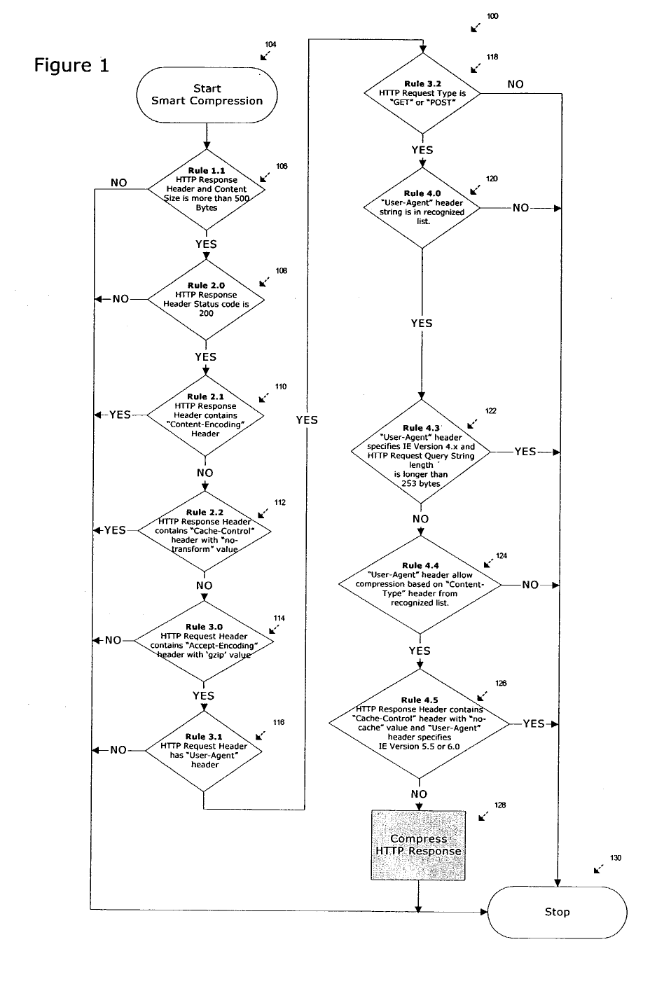

The present disclosure is generally directed toward novel methods and systems of determining whether to compress a computer communication, and more specifically, whether to compress a Hypertext Transfer Protocol (HTTP) response. Many specific details of certain embodiments of the invention are set forth in the following description and in FIGS. 1-5 to provide a thorough understanding of such embodiments. One skilled in the art will understand, however, that the present invention may have additional embodiments, or that the present invention may be practiced without several of the details described in the following description.

The present standard protocol for computer communications over standard communications networks, such as the global communications network or Internet, is the Hypertext Transfer Protocol (HTTP). The HTTP is a widely known, application-level communications protocol for distributed information systems. The HTTP can be used for many tasks, and allows systems to be built independently of the data being transferred. The HTTP utilizes request and response headers, as described more fully, for example, in the “Internet Official Protocol Standards”, or in “Hypertext Transfer Protocol—HTTP/1.1” by The Internet Society (1999), presently found at http://www.w3.org/protocols/rfc2616.html and incorporated herein by reference. It should be noted, however, that although the following detailed description contains numerous references to the HTTP, the inventive methods and systems disclosed herein are not necessarily limited to the HTTP, and may be implemented with any suitable communications protocol.

FIG. 1 is a flow diagram illustrating a process 100 for determining whether to compress an HTTP response 102 in accordance with an embodiment of the invention. The process 100 may be utilized, for example, after an HTTP request 105 has been received by a server from a requester, and after the corresponding HTTP response 102 has been determined or created by the server, but prior to the transmittal of the HTTP response 102 back to the requester. As described more fully below, the HTTP request 105 and the HTTP response 102 may include one or more “headers” of information that may be used by the process 100 in determining whether to compress the HTTP response 102. Various other characteristics of the HTTP request 105 and HTTP response 102 may also be utilized in making this determination. In the embodiment of the inventive process 100 shown in FIG. 1, all rules must pass before the HTTP response 102 is compressed. If any rule fails to pass (i.e. fails to be satisfied), the HTTP response 102 is not compressed and is sent unmodified to the requesting client.

As shown in FIG. 1, the process 100 begins at step 104, which may occur, for example, after an HTTP request 105 has been received by a server and after the HTTP response 102 has been determined. In step 106 (Rule 1.1) the content size of the HTTP response 102 is examined. If the content size is less than an established minimum size (e.g. 500 bytes), the HTTP response 102 is not compressed, and the process 100 terminates (step 130) with respect to the current HTTP response 102. If it is determined that the content size is larger than 500 bytes, processing continues to step 108 (Rule 2.0).

In step 108 (Rule 2.0) the HTTP response 102 status is examined, and if the response status code is not a predefined acceptable value (e.g. the value “200”), the HTTP response 102 is not compressed and the process terminates (step 130) with respect to the current HTTP response 102. It will be recognized by persons of skill in the art that the response status code of “200” corresponds to a successful response of data from the web server, and that this data is therefore eligible for compression. For other response status codes (e.g. “404” for “File Not Found,” “500” for “Error from the Server,” “302” and “303” for “Pages Moved”, etc.), these types of response status codes do not contain large amounts of data, and therefore, may not need to be compressed.

If the response status code is the predefined acceptable value (step 108), the process 100 proceeds to step 110 (Rule 2.1) and checks for a “content-encoding” HTTP response header 111. If the content-encoding HTTP response header 111 is already in the HTTP response 102, then the HTTP response 102 is already compressed and the process 100 terminates (step 130) with respect to the current HTTP response 102.

In step 112 (Rule 2.2), the process 100 determines if there is a “cache-control” HTTP response header 113, and if so, checks the value of the header 113. If the “cache-control” header 113 is present and the value is a predefined value (e.g. a value of “no-transform” or an equivalent version thereof) the HTTP response 102 is not compressed, and the process 100 terminates (proceeds to step 130) with respect to the current HTTP response 102.

Continuing to step 114 (Rule 3.0) the HTTP request 105 is examined for an “accept-encoding” header 115. If this header 115 is not found or the value of the header 115 is not a recognized value that indicates that encoded responses are acceptable, such as the current industry-standard value “gzip”, the HTTP response 102 is not compressed and the process 100 terminates (proceeds to step 130) with respect to the current HTTP response 102.

In step 116 (Rule 3.1) the process 100 checks for a “user-agent” header 117 within the HTTP request 105. If no “user-agent” header 117 is found, the HTTP response 102 is not compressed and the process 100 terminates (proceeds to step 130) with respect to the current HTTP response 102. If the “user-agent” header 117 is found, then in step 118 (Rule 3.2), the process 100 examines the HTTP request 105 to determine its type 119. If the type 119 of the HTTP request 105 is not within a predefined category of types that are compatible with compression, including, for example, the types “POST” or “GET,” the HTTP response 102 is not compressed and the process 100 terminates (proceeds to step 130) with respect to the current HTTP response 102.

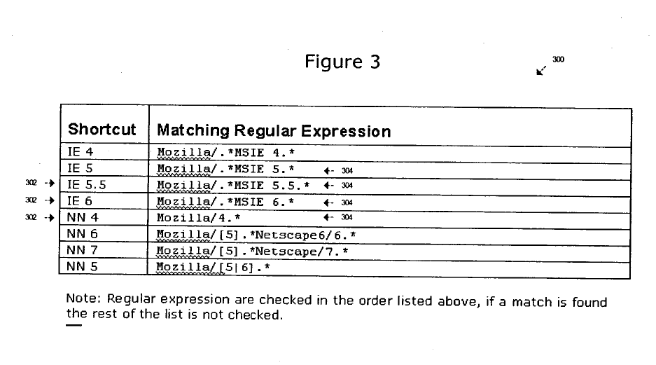

In step 120 (Rule 4.0), the “user-agent” header 117 of step 116 is checked against a list 300 of regular expressions 302 to determine if the requester's browser is of a type that will accept a compressed HTTP response 102b. FIG. 3 shows a representative list 300 of browser types 304 and the corresponding regular expressions 302 that indicate which browser type 304 the requester is using. In step 120, each regular expression 302 from the list 300 may be checked sequentially to determine whether the requester's browser is within the list 300, and if a match is found, the remainder of the regular expressions 302 from the list 300 need not be checked.

In one aspect of the invention, only browsers that are contained in the list 300 (FIG. 3) may be eligible for receiving a compressed HTTP response 102b. For example, Internet Explorer® (IE) version 3.0 and below, and Netscape® (NN) version 3.0 and below, do not support compression and are not included in the list 300. Alternately, if the requester's browser is not contained in the list 300, other actions may be taken to determine whether compression remains an option, including, for example, downloading a software patch or utility that supports compression. In the process 100 shown in FIG. 1, if the “user-agent” header 117 does not match one of the regular expressions 302 from the list 300, the HTTP response 102 is not compressed, and the process 100 terminates (proceeds to step 130) with respect to the current HTTP response 102.

One may note that FIG. 3 is not an exhaustive list of all known browser types, and that step 120 is not limited to the representative list of browser types shown in FIG. 3. Indeed, those of skill in the art may recognize that a greater or fewer number of browser types 302 and regular expressions 304 may be contained in the list 300, and that the process 100 is not limited to the particular embodiment shown in FIG. 3.

Proceeding to step 122 (Rule 4.3), the process 100 determines whether the “user-agent” header 117 specifies a particular browser version (e.g. IE version 4.x) and also checks a query string length of the HTTP request 105. If the query string length is within an acceptable size for the user-agent's browser version (e.g. less than 253 bytes for IE versions 4.x), then the process 100 proceeds to step 124. If not, the HTTP response 102 is not compressed and the process 100 terminates (proceeds to step 130) for the current HTTP response 102.

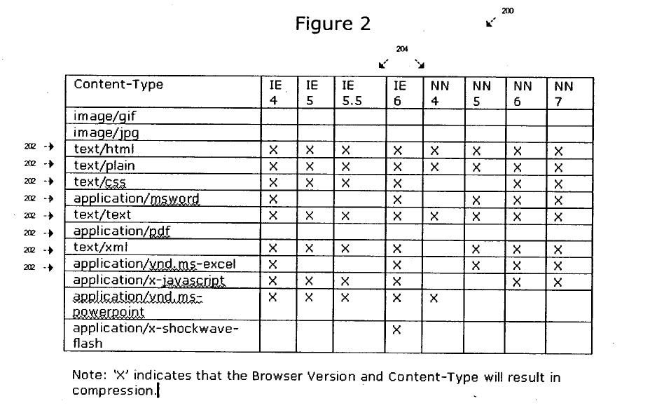

With continued reference to FIG. 1, the process 100 then proceeds to step 124 (Rule 4.4) in which a “content-type” HTTP response header 125 is examined, along with the “user-agent” header 117, to verify that the specified browser and content type are capable of being properly uncompressed at the requester's browser. FIG. 2 is a table (or matrix) 200 illustrating a representative list of content types 202 and a corresponding representative list of browser types 204, and the capability of each browser type 204 to uncompress (or decompress) each respective content type 202. As shown in FIG. 2, various browser types 204 are capable of receiving and uncompressing various content types 202. For example, if the recognized browser type 204 is IE 0.5.5, and the “content-type” header 125 indicates a content type 202 corresponding to “image/jpg”, the HTTP response 102 will not be compressed because the browser type 204 is unable to uncompress a compressed response of this content type 202. If, however, the content type 202 for the same browser 204 specifies “text/html”, the HTTP response 102 would be eligible for compression.

One may note that FIG. 2 is not an exhaustive list of all known content types or browser types, and that step 124 is not limited to the representative lists of content types or browser types shown in FIG. 2. Indeed, persons skilled in the art may recognize that a greater or fewer number of content types or browser types may be employed in the process 100, and the process is not limited to the particular embodiment shown in FIG. 2.

The process 100 next proceeds to step 126 (Rule 4.5), in which an additional check is made to determine whether the “user-agent” header 117 specifies IE version 5.5 or IE version 6.0. If so, the HTTP response 102 is checked for a “cache-control” header 127. The cache-control header 127 tells the clients to the server whether the server wants the data contained in the HTTP response 102 cached on the client. In this embodiment of the process 100, if the “cache-control” header 127 is present and the value is “no-cache”, then the data is not supposed to cache, and the HTTP response 102 is not compressed and the process 100 terminates (proceeds to step 130) for the current HTTP response 102. This action may avoid problems with certain browsers that may cache data when the HTTP response 102 is compressed even though this is not the intent of the server. Thus, to avoid the problem of incorrectly caching on the client computer, if the “cache-control” header 127 is “no-cache” in step 126, the HTTP response 102 is not compressed. In an alternate aspect, step 126 may be altered to compress or not to compress the HTTP response 102 for any suitable combination of cache-control header 127 and browser type shown in FIG. 2.

In the particular embodiment of the process 100 shown in FIG. 1, if all of the steps (or rules) are successfully passed and the HTTP response 102 remains eligible for compression, then the process 100 proceeds to step 128 and the HTTP response 102 is compressed into a compressed HTTP response 102b. In step 128, the HTTP response 102 may be compressed using any desired compression algorithm, including but not limited to any of the compression algorithms that are presently widely known and commercially available.

Clearly, the process 100 depicted in FIG. 1 is one embodiment of a method of determining whether to compress an HTTP response 102, and a wide variety of alternate embodiments may be readily conceived in accordance with the teachings of the present disclosure. For example, one or more steps (or rules) of the process 100 may be combined, altered, or eliminated to produce further embodiments of inventive methods of determining whether to compress an HTTP response. In addition, any of the predetermined values, expressions, content types, or other parameters involved in the various steps of the process may be varied from the particular values described above, including, for example, the predetermined values described above with respect to steps 106, 108, 112, 114, 116, and 122. Furthermore, although the present disclosure makes reference to specific browsers and response content types, alternate embodiments in accordance with the present teachings may be conceived that operate in accordance with other browser types, or other content types, or which utilize other regular expressions, and such alternate embodiments are not limited to the particular embodiments shown in FIGS. 2 and 3. A variety of other aspects of the process 100 may also be varied, including but not limited to the ordering of the steps of the process, without departing from the spirit or scope of the invention.

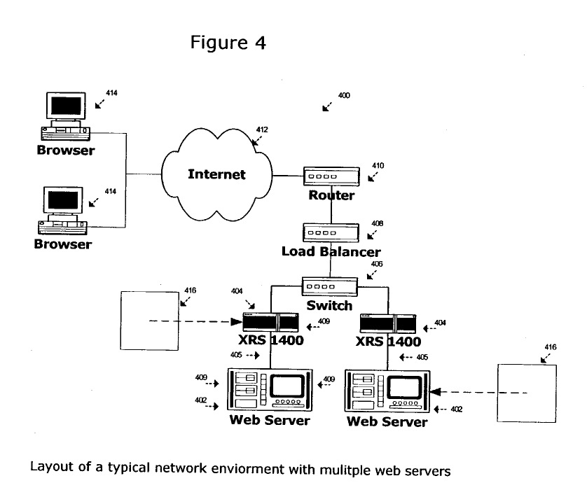

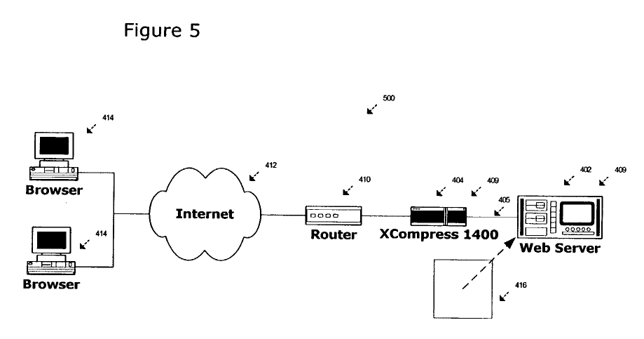

The above-described process 100, and alternate embodiments thereof, may be implemented on a variety of computer network environments. For example, FIG. 4 is a network environment 400 having multiple web servers 402, while FIG. 5 is another network environment 500 having a single web server 402. The following description of the representative computer network environments 400, 500 shown in FIGS. 4 and 5 is intended to provide a brief, general description of suitable computer hardware and a suitable computing environment in conjunction with which methods in accordance with the teachings of the present disclosure may be implemented. Although not required, the inventive methods may be implemented as computer-executable instructions, such as program modules, and may be executed by any of a wide variety of known computers or processors. Generally, such program modules include software programs, routines, data structures, and other known components that perform particular tasks or implement particular abstract operations.

As shown in FIG. 4, the network environment 400 includes a pair of web servers 402, each web server 402 being operatively coupled to a compression module 404 via, for example, a data bus 405. The compression module 404 (labeled as Xcompress 1400 in FIGS. 4 and 5) is a known computer appliance that implements the smart compression technology of the present disclosure, and is sold by Post Point Software, Inc. of Bellingham, Wash. In turn, the compression modules 404 and are coupled to a switch 406 which transmits and receives signals between the compression modules 404 and a balancer 408. The web servers 402 and the compression modules 404 are of known construction, and may include, for example, a processor 403, a memory 407 (e.g. a read only memory (ROM), a random access memory (RAM), a dynamic random access memory (DRAM), a programmable read only memory (EPROM), etc.), a drive 409 for reading computer-readable media, a hard disk, and communication ports for transmitting and receiving signals to other components. Typically, a basic input/output system (BIOS) (not shown) may be installed on the ROM of each component, such as during start-up, to provide the basic routings that help to transfer information between components within the network environment 400, 500.

As further shown in FIGS. 4 and 5, a router 410 is operatively coupled between the balancer 408 and a communications link 412 (e.g. the internet, an intranet, an extranet, etc.). A plurality of browsers 414 are coupled to the communications link 412. Each of the components shown in FIG. 4 is known and commercially available, and for the sake of brevity, will not be described in detail. In the network environment shown in FIG. 5, one of the web servers 402 has been eliminated, along with its corresponding compression module 404, the switch 406, and the balancer 408.

In accordance with the invention, a machine-readable medium 416 may be used to store a set of machine-readable instructions (e.g. a computer program) embodying a method for determining whether to compress an HTTP response 102 in accordance with the teachings of the present invention. The machine-readable medium 416 may be any type of medium which can store data that is readable by a computer, including, for example, a floppy disk, CD ROM, optical storage disk, magnetic tape, flash memory card, digital video disk, RAM, ROM, or any other suitable storage medium. The machine-readable medium 416, or the instructions stored thereon, may be temporarily or permanently installed in any desired component of the network environment 400, 500, such as the compression modules 404 shown in FIGS. 4 and 5 via the component's drive 409, or in ROM on the component's hard drive. Alternately, the compression modules 404 may be eliminated, and the process may be implemented directly into the servers 402, the router 410, or in any other desirable component of the system.

In operation, the HTTP request 105 may be transmitted from at least one browser 414 via the communication link 412 to the web server 402. The web server 402 then provides the appropriate uncompressed HTTP response 102. In the manner described above, the computer program 416 embodying the inventive process 100 then determines whether to compress the HTTP response 102, and if the result of the determination is in the affirmative, performs the desired compression to produce the compressed HTTP response 102b. The compressed HTTP response 102b is then transmitted via the communication link 412 back to the appropriate browser 414, which may then uncompress the compressed HTTP response 102b for the requester.

The inventive methods and apparatus described above advantageously provide improved processes for determining whether to compress a computer communication prior to transmittal. For example, the above-described processes provide improved reliability that a proper determination regarding whether to compress a communication will be made. This is particularly true for those types of communication content that may not be universally uncompressed by all types of browsers. Furthermore, processes in accordance with the above-noted teachings also provide improved determinations regarding whether to expend computational resources to compress a communication, thereby improving overall system efficiencies and conserving valuable computational resources.

In addition, the inventive methods and apparatus advantageously allow compression technology to be employed in an optimum fashion, with consequent reductions in bandwidth usage and transmission times, resulting in corresponding improvements in network efficiency, and reducing capital and operating expenditures. Because of these factors, the end user will experience quicker, more reliable results to requests for information, thereby improving the user's satisfaction with the network environment.

Thus, although specific embodiments of, and examples for, the invention are described herein for illustrative purposes, various equivalent modifications are possible within the scope of the invention, as those skilled in the relevant art will recognize. The teachings provided herein can be applied to other methods and apparatus for determining whether to compress a computer communication, and not just to the embodiments described above and shown in the accompanying figures. Accordingly, the scope of the invention should be determined from the following claims.

1. A method of determining whether to compress a responsive communication prior to transmittal to a requester, comprising:
receiving a communication request;
generating an uncompressed responsive communication corresponding to the communication request;
examining at least one of a request characteristic of the communication request and a response characteristic of the uncompressed responsive communication, the request characteristic of the communication request being other than an “accept-encoding” header;
applying one or more rules to the at least one of the request characteristic and the response characteristic, each of the one or more rules providing a compressibility assessment; and
based on the one or more compressibility assessments, determining whether to compress the responsive communication prior to transmittal to the requester.

2. The method according to claim 1 wherein applying one or more rules to the at least one of the request characteristic and the response characteristic comprises assessing whether the responsive communication is greater than or equal to a predetermined minimum size.

3. The method according to claim 1 wherein applying one or more rules to the at least one of the request characteristic and the response characteristic comprises assessing whether the responsive communication includes a response status code having a predefined acceptable value.

4. The method according to claim 1 wherein applying one or more rules to the at least one of the request characteristic and the response characteristic comprises assessing whether the responsive communication includes a cache-control header having a predefined acceptable value.

5. The method according to claim 1 wherein applying one or more rules to the at least one of the request characteristic and the response characteristic comprises assessing whether the communication request is within a predefined category of types.

6. The method according to claim 5 wherein assessing whether the communication request is within a predefined category of types includes assessing whether the communication request is at least one of a POST or GET type request.

7. The method according to claim 1 wherein applying one or more rules to the at least one of the request characteristic and the response characteristic comprises assessing whether the communication request is transmitted from a request browser that is within a predefined category of browser types.

8. The method according to claim 1 wherein applying one or more rules to the at least one of the request characteristic and the response characteristic comprises determining a request browser type that transmitted the communication request, and assessing whether the communication request is within an acceptable size for the request browser type.

9. The method according to claim 1 wherein applying one or more rules to the at least one of the request characteristic and the response characteristic comprises determining a request browser type that transmitted the communication request, and assessing whether the communication request includes a content type that can be properly uncompressed by the request browser type.

10. The method according to claim 1 wherein applying one or more rules to the at least one of the request characteristic and the response characteristic comprises determining whether the communication request includes a particular cache-control value of a predefined value.

11. A machine-readable medium having instructions stored thereon for execution by a processor to perform a method of determining whether to compress a responsive communication prior to transmittal to a requester, comprising:
receiving a communication request;
generating an uncompressed responsive communication corresponding to the communication request;
examining at least one of a request characteristic of the communication request and a response characteristic of the uncompressed responsive communication, the request characteristic of the communication request being other than an “accept-encoding” header;
applying one or more rules to the at least one of the request characteristic and the response characteristic, each of the one or more rules providing a compressibility assessment; and
based on the one or more compressibility assessments, determining whether to compress the responsive communication prior to transmittal to the requester.

12. The machine-readable medium according to claim 11 wherein applying one or more rules to the at least one of the request characteristic and the response characteristic comprises assessing whether the responsive communication is greater than or equal to a predetermined minimum size.

13. The machine-readable medium according to claim 11 wherein applying one or more rules to the at least one of the request characteristic and the response characteristic comprises assessing whether the responsive communication includes a response status code having a predefined acceptable value.

14. The machine-readable medium according to claim 11 wherein applying one or more rules to the at least one of the request characteristic and the response characteristic comprises assessing whether the responsive communication includes a cache-control header having a predefined acceptable value.

15. The machine-readable medium according to claim 11 wherein applying one or more rules to the at least one of the request characteristic and the response characteristic comprises assessing whether the communication request is within a predefined category of types.

16. The machine-readable medium according to claim 15 wherein assessing whether the communication request is within a predefined category of types includes assessing whether the communication request is at least one of a POST or GET type request.

17. The machine-readable medium according to claim 1 wherein applying one or more rules to the at least one of the request characteristic and the response characteristic comprises assessing whether the communication request is transmitted from a request browser that is within a predefined category of browser types.

18. The machine-readable medium according to claim 11 wherein applying one or more rules to the at least one of the request characteristic and the response characteristic comprises determining a request browser type that transmitted the communication request, and assessing whether the communication request is within an acceptable size for the request browser type.

19. The machine-readable medium according to claim 11 wherein applying one or more rules to the at least one of the request characteristic and the response characteristic comprises determining a request browser type that transmitted the communication request, and assessing whether the communication request includes a content type that can be properly uncompressed by the request browser type.

20. The machine-readable medium according to claim 111 wherein applying one or more rules to the at least one of the request characteristic and the response characteristic comprises determining whether the communication request includes a particular cache-control value of a predefined value.

21. A computer system, comprising:
a processor;
a computer-readable medium;
a communications port; and
a computer program executed by the processor from the medium to perform a method of determining whether to compress a responsive communication prior to transmittal to a requester, wherein the method includes
receiving a communication request via the communications port;
generating an uncompressed responsive communication corresponding to the communication request;
examining at least one of a request characteristic of the communication request and a response characteristic of the uncompressed responsive communication, the request characteristic being other than an “accept-encoding” header;
applying one or more rules to the at least one of the request characteristic and the response characteristic, each of the one or more rules providing a compressibility assessment; and
based on the one or more compressibility assessments, determining whether to compress the responsive communication prior to transmittal to the requester.

22. The computer system according to claim 21, further comprising a web server, the processor being disposed within the web server.

23. The computer system according to claim 21, further comprising a compression module, the processor being disposed within the compression module.
